(19) United States
(12) Patent Application Publication
(10) Pub. No.: US 2009/0059004 A1
(43) Pub. Date: Mar. 5, 2009

(54) System and Method for Monitoring the Handling of a Shipment of Freight

(75) Inventor: Joseph M. Bochicchio, Charlotte, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Speed Trac Technologies, Inc.

(21) Appl. No.: 11/848,744

(22) Filed: Aug. 31, 2007

(51) Int. Cl. H04N 7/18

(52) U.S. Cl. 348/148; 348/E07.085

(57) ABSTRACT

The invention provides a system and method in which a lift truck that is equipped with a weighing device; a remote computer, an input device, and a display screen. The display screen is located on the lift truck in a position that permits the operator to see information displayed thereon. During use, the operator of the lift truck inputs identifying information for the piece of freight into the computer and obtains a weight of the piece of freight with the weighing device. This information is displayed on the display screen. A video imaging device disposed on the lift truck captures video image data of information displayed on the display device. The captured video image data is communicated from the lift truck to a receiver and is displayed on a second display device within the freight terminal. The displayed video images can be monitored to verify that lift truck operators are obtaining weight data for pieces of freight.

### FIELD OF THE INVENTION

This invention relates to a system and method for monitoring the shipment of freight that is useful in the freight shipment industry.

### BACKGROUND OF THE INVENTION

Typically, in the freight shipment industry, shipments of freight are received from a shipper by the freight carrier, accumulated at freight terminals where they are sorted by shipment destination and then loaded onto tractor-trailer trucks for shipment. At a receiving terminal, the shipments of freight are unloaded, and sorted for trans-shipment or delivery. Usually, the freight shipment is arranged on one or more pallets, and the loading and unloading is handled by lift trucks. Each shipment of freight is assigned an identifying number, and this number is used for tracking the freight from its origin to its destination.

Shipping charges are based upon the weight and the classification of the freight shipment and its weight. Typically, the weight of the shipment is provided to the freight carrier by the shipper on a bill of lading, and the shipment charges are calculated based upon the stated weight provided by the shipper. In some cases the shipment weight provided by the shipper is understated, which can result in a significant loss of revenue to the freight carrier. The freight carrier may conduct spot checks by reweighing selected shipments, but in most instances, the stated weight provided by the shipper is used as the basis for the freight charge, since it has not been feasible to reweigh each piece of freight handled by the freight carrier.

To address this problem, various systems have been developed in which lift trucks used by the freight carrier for handling and loading freight shipments are equipped with a weighing device capable of weighing each piece of freight handled by the lift truck. The freight carrier can use the actual weight of the piece of freight to recalculate the freight charge and thereby capture revenue which otherwise would be lost. Unfortunately, it has proven difficult to have some lift truck operators consistently weigh each piece of freight. As a result, there is a need for a system and method that can be used to more effectively ensure that lift truck operators are obtaining weight data for each piece of freight.

### BRIEF SUMMARY OF THE INVENTION

The present invention is directed to a system and method of monitoring the handling of freight within a freight terminal that helps verify that lift truck operators are performing their duties with respect to obtaining weight data for pieces of freight. In one embodiment, the system and method includes a lift truck that is equipped with a weighing device; a remote computer, an input device, and a display screen. The display screen is located on the lift truck in a position that permits the operator to see information displayed thereon. During use, the operator of the lift truck inputs identifying information for the piece of freight into the computer and obtains a weight of the piece of freight with the weighing device. This information is displayed on the display screen. A video imaging device disposed on the lift truck captures video image data of the display device along with the information displayed thereon. The thus captured video image data is communicated from the lift truck to a receiver within the freight terminal, and is then displayed on a second display device within the freight terminal. Personnel within the freight terminal can monitor the captured video image data to verify that the lift truck operator is obtaining weight data for the piece of freight. Lift truck operators failing to obtain weight data can be quickly identified so that appropriate action can be taken.

In a preferred embodiment, the captured video image data is displayed in real time so that the events are displayed as they occur. As noted above, personnel within the freight terminal can monitor the video image data to ensure that the lift truck operator is inputting the identifying information for the freight as well as obtaining the weight of the piece of freight. By monitoring the captured video image data, personnel within the freight terminal will be informed if a lift truck operator is failing to obtain weight data for the freight.

In one embodiment, the system includes at least one computer having executable program modules thereon that are configured to perform one or more functions with respect to the handling of the freight. Preferably, the computer includes an executable program module that is operable in the computer and is configured to create a segment of video image data that corresponds to the handling of the piece of freight by the lift truck operator. The segment of video image data can be associated with the identifying information and stored in a database from which it can be recalled. The freight carrier's computer system also includes an executable program module for recalling and effecting display of the video segment. Generally, the video segment can be recalled and viewed at the freight terminal or a centralized location, such as the freight carrier's central office. Additionally, the video segment can be recalled and displayed at the destination terminal for the piece of freight.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic illustration of a system and method of shipping freight that is in accordance with one aspect of the invention;

FIG. 2 is a perspective view showing a lift truck equipped with a weighing device, a display screen and an imaging device for capturing video image data of the display screen;

FIG. 3 is a perspective view illustrating exemplary captured video image data of a display device disposed on the lift truck;

FIG. 4 depicts a display device that is configured to display captured video image data of a plurality of lift trucks operating within the freight terminal; and

FIG. 5 depicts a lift truck having an imaging device for obtaining image data from which the volume of a piece of freight can be calculated.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

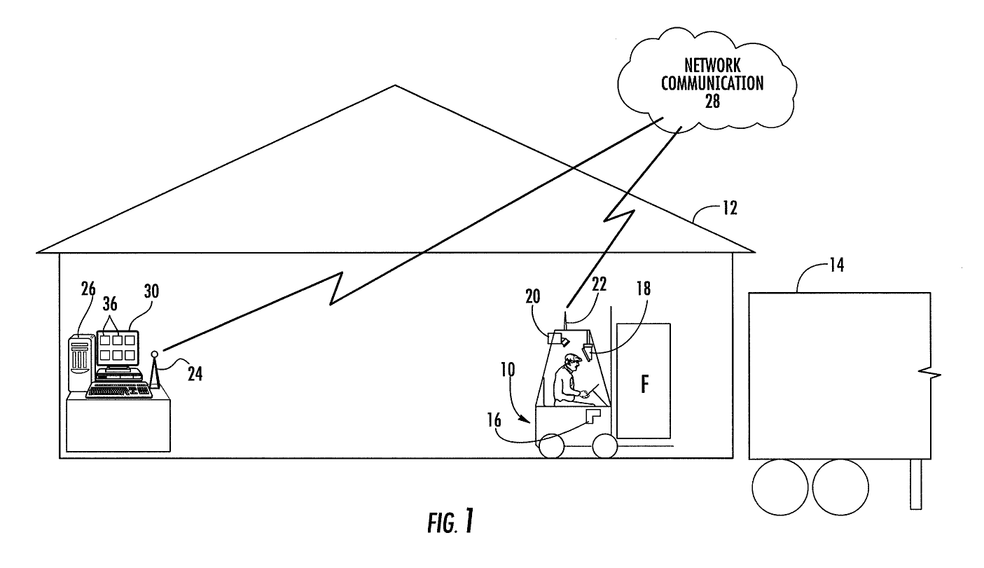

FIG. 1 is a schematic illustration of the system and method for monitoring the shipment of a piece of freight within a freight terminal that is in accordance with the present invention. In FIG. 1 pieces of freight F are received and handled by one or more lift trucks 10 within in a freight terminal 12. Generally, the freight terminal includes a number of trailers 14 arranged at a loading dock for receiving and unloading pieces of freight.

The lift truck is equipped with a weighing device (not shown) for obtaining the weight of a piece of freight. The weighing device may comprise a load cell mounted to one of the forks of the forklift. Suitable load cells for this purpose are commercially available from various sources. The load cell is capable of determining the weight of a piece of freight when the lift truck lifts the piece of freight from the ground. The load cell is of such accuracy that it can function as a “legal for trade” weighing device. The lift truck also includes an input device 16 that is accessible to the operator of the lift truck and is configured for inputting information for the piece of freight into a computer (not shown). A display device 18 having a display screen is disposed on the lift truck and is positioned in a location that permits the operator of the lift truck to see information displayed on the display screen. As discussed in greater detail below, the information displayed on the display device can include the identity of the piece of freight, such as a pro number, stated weight of the piece of freight, and the actual weight of the piece of freight obtained with the weighing device. The display device can also be used to communicate information to the lift truck operator with respect to handling of the piece of freight and to which loading dock/trailer the piece of freight is to be delivered.

Each lift truck 10 also includes a video imaging device 20 that is positioned on the fork lift to capture video image data of the information displayed on the display screen. For example, in the illustrated embodiment the video imaging device 20 is positioned behind the lift truck operator so that the video image data of the information displayed on the display screen can be captured. In the illustrated embodiment, the lift truck is equipped with a wireless transmitter (not shown) which is connected to an antenna 22.

During operation, the video imaging device 20 captures video image data of the display screen as the lift truck operator inputs identifying information for the piece of freight into the computer and obtains the weight of the piece of freight. The identifying information and the weight are displayed on the display screen. The captured video image data that includes the identifying information and the weight of the piece of freight is wirelessly communicated from the video imaging device 20 via the transmitter to a receiver 24 at a receiving site located within the freight terminal. The receiver 24 is typically communicatively connected with a base computer 26 located in the freight terminal and that is part of the freight carrier's computer system. The freight terminal typically includes a wireless communications network 28 through which information can be communicated from the lift trucks to the receiver, and vice versa. A second display device 30 in the freight terminal is configured to receive and display the captured video image data 36 so that the information displayed on the display device 18 of the lift truck can be seen by personnel within the freight terminal. Freight terminal personnel can monitor the captured video image data for each lift truck to ensure that the lift truck operators are inputting the identifying information into the computer as well as obtaining a weight for each piece of freight. Preferably, the second display device 30 is capable of simultaneously displaying video image data for multiple lift trucks that are operating within the freight terminal.

In a preferred embodiment, each lift truck 10 is also equipped with a remote computer (not shown) that is operatively connected and in communication with one or more of the weighing device, input device, display device, wireless transmitter, and video imaging device. The remote computer on each lift truck can be in communication with the base computer and both are preferably capable of communicating information between each other. For example, the remote computer can be configured to send identifying information for the piece of freight and the obtained weight for the piece of freight to the base computer via receiver 24. This information can then be used by the freight carrier's computer system to generate a new invoice for shipping the piece of freight. The base computer upon receiving the identifying information for the piece of freight can send information regarding the piece of freight to the remote computer that can then be displayed on the display device 18. Such information may include special handling instructions for the piece of freight, the trailer or loading dock to which the piece of freight is to be delivered, shipper stated weight, freight classification, and the like. The base computer, upon receiving identify information and the actual weight of the piece of freight can store this information in a database from which it can be recalled. In some embodiments, the captured video image data is also communicated from the remote computer to the receiver.

Alternatively, the various devices disposed on the lift truck may be operatively connected to the base computer 26 via the wireless transmitter. In this embodiment, the inputted information, weight of the piece of freight, captured video image data may be communicated directly from each respective device to the base computer via the wireless transmitter. The base computer in turn can also be configured to communicate information to the display device 18 that is to be displayed on the display screen so that the operator of the lift truck can see the information. As discussed in greater detail below, at least one of the base computer or remote computer includes computer-readable program codes for performing one or more operations and/or functions in connection with the various aspects of the present invention.

Video imaging devices that may be used in the invention include analog video cameras, digital video cameras, color and monochrome cameras, closed-circuit television (CCTV) cameras, analog and digital cameras, PC cameras, web cameras, and infra-red imaging devices, or any device that can capture video image data. The selection of a particular camera type for a particular freight terminal may be based on many factors including environmental lighting conditions, the frame rate and data acquisition rate, and the ability to process data from the lens of the camera within the electronic circuitry of the camera control board, the size of the camera and associated electronics, the ease with which a camera can be mounted as well as powered, the lens attributes which are required based on the physical layout of the freight terminal and the relative position of the video imaging device to the display device, as well as the cost of the camera. Exemplary video imaging device that may be used in the practice of the invention are available from Sony such as Sony Handycam Camcorder model number DCR-SR80.

The input device 16 typically comprises any device that can be used to input information, such as identifying information, into the freight carrier's computer system (e.g., the remote or base computers). The input device can be a conventional commercially available bar code scanner, whereby the scanner will read coded identifying information in the form of a bar code when the scanner is pointed at the bar code and activated, such as pressing a switch or pulling a trigger. Alternatively, the scanner can be a device for reading coded identifying information from a RFID tag associated with the piece of freight. In some embodiments, the input device can include a keyboard, touchpad, and the like. In a preferred embodiment, the system can include an input device comprising a scanner as well as a touch pad that is an integral part of the display device.

Generally, the information inputted into the system includes identifying information for a piece of freight. In the context of the invention, the term “identifying information” includes information that is associated with a specific piece or pieces of freight. Identifying information may include identification of the shipper; an identification code or number for the shipment of freight, such as a pro number. Additional information that can be associated with the identifying information, and hence the piece of freight, includes the number of pieces in the shipment, the consignee name and address, the number of pieces in the shipment, estimated value of the freight shipment, description and classification of the shipment, and if applicable, handling instructions, such as an MSDS, stated weight of the shipment of freight, identification of the truck driver, digital image of the freight, date and time, etc. Preferably, the freight specific information may also include a unique freight bill number, such as the “pro number”.

The identifying information can be in form of a machine readable code, such as 1-D bar code, 2-D bar code, RFID tag, or combination thereof. The coded identifying information can either be affixed directly to the piece of freight, or it can be provided on a document that is associated with the piece of freight. If it is affixed to the piece of freight, the lift truck operator will simply aim the scanner at a bar code or RFID tag on the piece of freight to read the coded information. It is conventional in the freight shipment industry to create a movement document that follows the freight shipment from its origin to its destination. This movement document may include the identifying information discussed above, such as the pro number, identification of the shipper, the consignee name and address, the number of pieces in the shipment, and a description of the shipment. If the movement document is used as the source of identifying information for the piece of freight, the lift truck operator will simply use the input device (e.g., a scanner) to scan the identifying information from a bar code on the movement document. If the identify information comprises a numerical or alpha numerical symbol, the lift truck operator can input this information into the computer using a keyboard or touchpad that is associated with the computer.

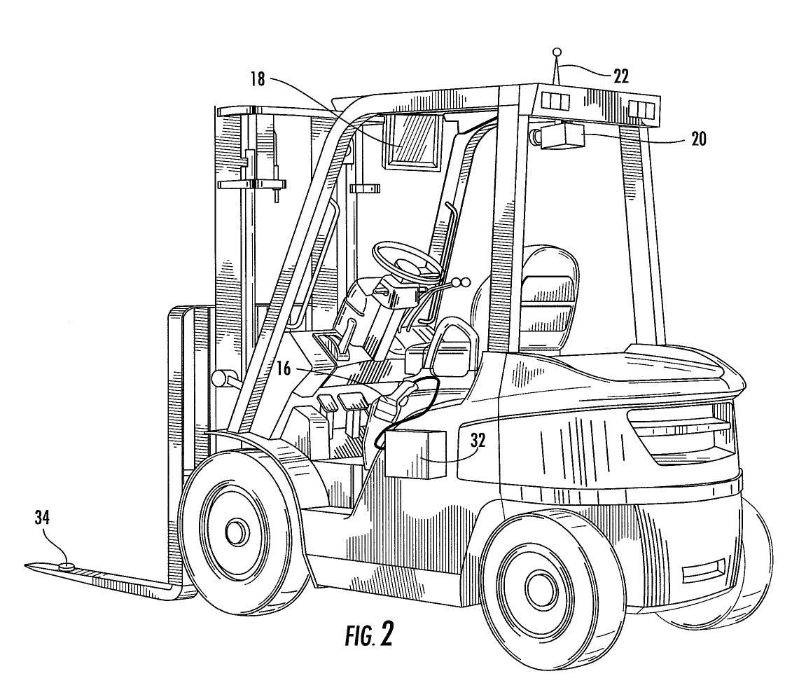

FIG. 2 illustrates one way in which the lift truck can be equipped for implementing the system and method of the present invention. In this embodiment, the lift truck includes a remote computer 32 that is mounted to the lift truck adjacent to the operator's seat. The remote computer 32 is in communication with display device 18 having a display screen, such as a LCD display, conveniently located for displaying information to the operator of the lift truck. In the embodiment shown in FIG. 2, the display device 18 is mounted to the roof cage of the lift truck directly in front of the lift truck driver. In the illustrated embodiment, the input device comprises a handheld bar code or RFID scanner that is connected to the remote computer 32 and is positioned so as to be readily accessible to the lift truck operator. The input device can also comprise a keyboard or similar device. The display device 18 can also function as an input device for receiving commands from the lift truck operator. For example, the display device 18 can be a touch-screen device, or it can be equipped with suitable keys or buttons, such as “soft keys” that have changeable identification labels that are shown on the display device. A load cell 34 mounted on the fork of the lift truck is also communicatively connected to the remote computer 32 by wires (not shown). An antenna 22 is mounted to the roof of the lift truck and is connected to the transmitter, which is housed with the computer 32.

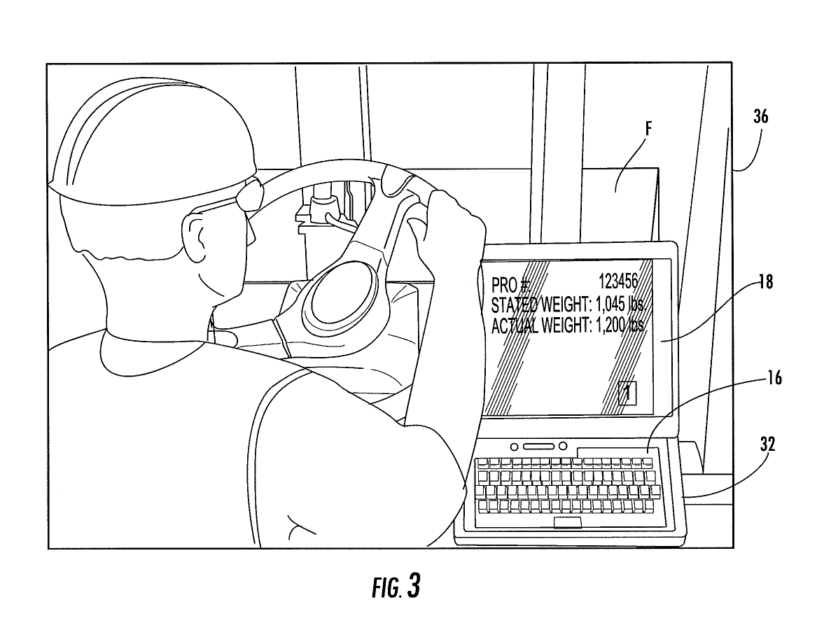

FIG. 3 illustrates an embodiment of the invention in which the system comprises a remote computer, display device, input device, transmitter, and antenna that are integrated into a single unit. Information from the load cell can be communicated to the remote computer either by cable or by a wireless connection, such as a Bluetooth link. As shown in FIG. 3, the remote computer and the display device 18 comprise an integrated unit that is in the form of a laptop computer. In this embodiment, the remote computer also includes a keyboard that can serve as an input device for inputting information, such as identifying information and instructions into the remote computer.

FIG. 3 also illustrates an example of the captured video image data 36 that is obtained by the video imaging device and displayed on the second display device. Preferably, the captured video image data includes the display screen of the display device 18 and the information displayed thereon. Exemplary information that can be displayed on the display device 18 includes identifying information, obtained weight, actual weight, and the like.

As briefly noted above, the system of the present invention includes computer-readable program codes for performing one or more operations and/or functions in connection with the various aspects of the present invention. The computer-readable program codes may include program modules, various algorithms, rules, and combinations thereof that facilitate the performance of their respective functions. The computer-readable program code may be in the form of software, hardware, and combinations thereof. The computer-readable code may be stored on a memory storage device that is associated with one or more of the remote computer or base computer.

The computer-readable program code includes a plurality of executable portions that are capable of performing one or more of the following: receiving input of identifying information for a piece of freight; receiving weight data for a piece of freight; displaying the identifying information and weight data on the display device of the lift truck; capturing video image data of the information displayed on the display device of the lift truck; communicating the identifying information, weight data, and captured video image data to a receiver at a receiving site in the freight terminal; displaying the captured video image data on a display device at the receiving site; storing the weight data and identifying information, and creating a new shipping charge based on the obtained weight data. It should be recognized that the executable program modules for performing one or more of the above functions may be operable in the remote computer, the base computer, or a combination thereof. For example, the remote computer may include executable program modules for displaying the identifying information and weight data on the display device of the lift truck, while the base computer includes executable program modules that cooperate with the video imaging device for capturing video image data of the information displayed on the display device of the lift truck, and executable program modules that cooperate with the second display device for displaying the captured video image data on the second display.

When a shipment of freight is received from a shipper, the system and method of the present invention is used to capture the actual weight of each piece of freight in the shipment. For example, as each piece of freight is handled by the lift truck at the freight terminal, the lift truck operator scans the identifying information for that piece of freight and the weight of the piece of freight is determined by the weighing device. The weight data and identifying information are communicated to the base computer and stored. As can best be seen in FIG. 3, this information is also displayed on the display device 18 of the lift truck. During this operation, the video imaging device captures video image data of the displayed information as the lift truck operator scans the identifying information and obtains the weight data for the piece of freight. The captured video image data is transmitted to the receiver and displayed on the second display device. Preferably, the captured video image data is displayed in real time so that the events are displayed as they occur. As noted above, personnel within the freight terminal cannot monitor the video image data to ensure that the lift truck operator is inputting the identifying information for the freight as well as obtaining the weight of the piece of freight. By monitoring the captured video image data, personnel within the freight terminal will be informed if a lift truck operator is failing to obtain weight data for the freight. As such, appropriate action can be taken to ensure that lift truck operator complies with the procedures for obtaining the weight of the freight.

In one specific embodiment of the present invention, the identifying information and weight data is captured by the driver of the lift truck in a simple “lift-shoot-shoot” sequence. For example, the driver lifts the piece of freight so that the load cell can obtain the weight of the piece of freight. Then the driver “shoots” the coded identifying information for that piece of freight by aiming the barcode scanner at the bar code provided on the movement document for that piece of freight. The identify information and the weight of the piece of freight are displayed on the display device disposed on the lift truck. When the lift truck operator has completed the operations with respect to the piece of freight, the operator “shoots” another predetermined barcode in order to signify to the system that the weighing and reading sequence has been completed. This other predetermined barcode can be located at any suitable location on the lift truck, such as, for example, on the display device located in front of the lift truck driver. The reading of this barcode functions as a signal to the system to close the file and to transmit the information to the base computer 26. Each transmission to the base computer can include the following information: coded identifying information read from the movement document or obtained from the piece of freight itself, total freight weight read by the load cell, forklift number, forklift operator identification, date and time, and location of the freight terminal where the information was obtained.

When the freight shipment is unloaded at the destination terminal, a similar “lift-shoot-shoot” procedure can be followed to capture the identifying information and actual weight of each piece of freight handled at the terminal. By comparing the actual weight of a shipment at the origin terminal to the weight of the shipment at the destination terminal, a loss control module can rapidly determine whether the shipment arrived intact, or whether there was any loss or pilfering. This information can also be utilized by a tracking module to provide information on the status and location of the shipment.

In one particular embodiment, the system of the present invention is configured to associate captured video image data for a particular piece of freight with identifying information, such as the pro number, for the piece of freight. The captured video image data is typically stored in a database or in a centralized computer system from which the video image data can be recalled and displayed on a display device. The stored video image data can be used at a later time to review events that may have occurred while the piece of freight was being handled by the lift truck operator. For example, the stored video image data can be recalled to determine the status and condition of the shipment of freight while at the freight terminal; trailer on which the piece of freight was loaded or a particular location within the freight terminal to which the operator of the lift truck delivered the piece of freight; whether the operator of the lift truck obtained a weight for the piece of freight; instructions displayed on the display device with respect to a piece of freight, and the like.

In a preferred embodiment, the computer (e.g., the base computer or the remote computer) includes an executable program module operable in the computer for creating a segment of video image data corresponding to the period of time for which the lift truck operator has handled the piece of freight, and an executable program module operable in the computer for associating the thus created video segment with the identifying information for the piece of freight. The segment of video image data is associated with the identifying information and stored in a database from which it can be recalled. The freight carrier's computer system also includes an executable program module for recalling and effecting display of the video segment. Generally, the video segment can be recalled and viewed at the freight terminal or a centralized location, such as the freight carrier's central office. Additionally, the video segment can be recalled and displayed at the destination terminal for the piece of freight.

The beginning and end points of the video segment (i.e., period of time encompassed by the segment of video image data) can be determined in a variety of different ways. For example, the beginning point of the segment can be inputted into the computer by the lift truck operator when a particular function is performed, such as inputting a command into the computer, for example, scanning a predetermined bar code; inputting identifying information for a piece of freight into the computer; obtaining a new weight value for a piece of freight; the loading of a piece of freight onto the tongs of the lift truck, and the like. The end point of the segment of video image data can be similarly determined, such as inputting a command into the computer; unloading the piece of freight from the lift truck; obtaining identifying information for a second piece of freight, and the like. Preferably, the period of time corresponding to the handling of the piece of freight begins when the lift truck operator initially handles the freight, such as inputting its identifying information or obtaining its weight, and ends when the lift truck operator has completed his work with respect to the piece of freight, such as unloading it from the lift truck. In one embodiment, the computer can be configured to end the segment of video image data when the lift truck operator inputs identifying information for a second piece of freight. For example, the executable program module that is operable for creating the segment of video image data can be configured to define a beginning point of the video segment when the computer receives input of the identifying information for the piece of freight, and define an ending point of the video segment when identifying information for a second piece of freight is received by the computer.

In a further aspect of the present invention, the system may also include an executable program module that monitors activities of the lift truck operator with respect to inputting information into the system. For example, the system can be configured to output a signal that indicates the current status of the lift truck operator, such as whether the lift truck operator is logged into the system or logged off the system. The system can also be configured to indicate whether the lift truck operator is actively inputting information and obtaining weight data, or if the lift truck operator has not recently obtained weight data for pieces of freight. For example, if a lift operator is logged into the system, but has not inputted weight data for a predetermined amount of time, such as 10 or 20 minutes, the computer can output a visual signal on the second display screen that alerts freight terminal personnel that the lift truck operator is failing to obtain weight data or otherwise input information into the system. Such a visual signal can comprise a change in color displayed on the second display device, change in gray-scale associated with the video image data, flashing images, timers, bar graphs, and the like.

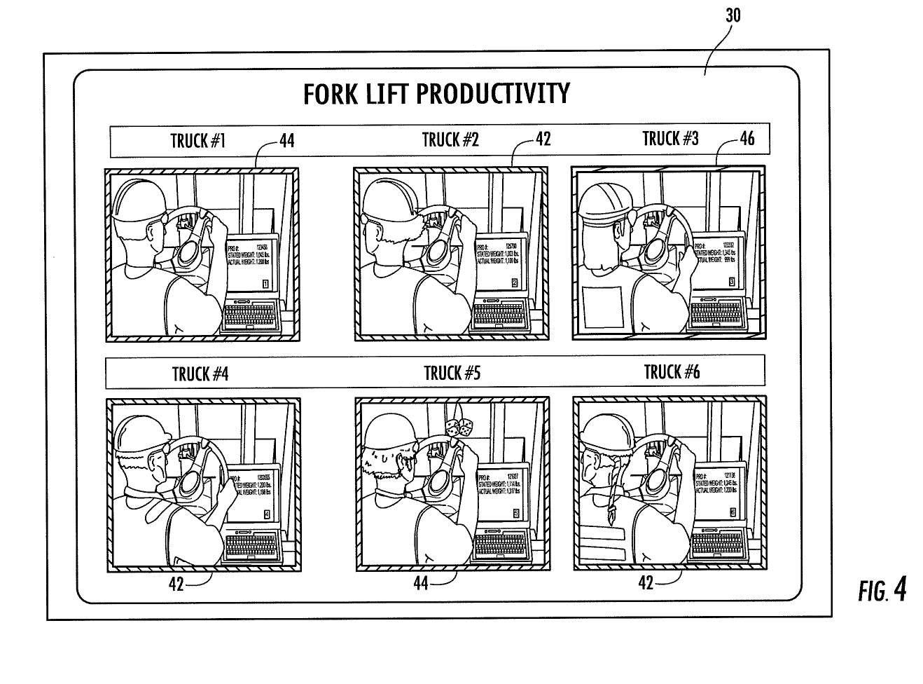

FIG. 4 illustrates an exemplary display screen 30 that can be used in the freight terminal to display captured video image data for a plurality of lift trucks, and that includes information displayed on the display device of each of the lift trucks. As noted above, the captured image video data for each lift truck can be used by personnel within the freight terminal to verify that each lift truck operator is performing their respective duties with respect to obtaining weight data for each piece of freight. As shown in FIG. 4, the captured video image data for each lift truck also includes a visual signal that alerts the personnel to the status of the lift truck operator. In FIG. 4 this visual signal comprises a colored perimeter that surrounds each of the captured video image data and that is represented by the hatched perimeter. For example, the captured video image data for trucks 1 and 5 have similar hatched lines (represented collectively by reference number 42), whereas the captured video image data for trucks 2, 4, and 6 have hatched perimeters (represented collectively by reference number 44), that are similar to each other and different than the appearance of the hatched perimeters 42 for lift trucks 1 and 5. The captured video image data for truck 3 includes a hatched perimeter 46 that is different than that of any of the other lift trucks. As discussed above, this visual signal can be used to determine the status of each lift truck operator with respect to the handling of pieces of freight. For example, hatched perimeter 42 may correspond to a color that indicates that the lift truck operator is logged into the system and is actively obtaining weight data for pieces of freight, whereas hatched perimeter 44 may correspond to a color that indicates that the lift truck operator is logged in, but has not inputted weight data or other information for a predetermined amount of time. The visual signal can be used to quickly alert personnel monitoring the display device 30 in the event lift truck operators are failing to obtain weight data or other information.

In another embodiment, the system can also include an executable program module, such as an unloading module, that is configured to cooperate with the freight carrier's computer system and to instruct the lift truck operator on where to take the freight within the terminal. For example, upon receiving the piece of freight, the unloading module can be configured to retrieve information from the base computer on where the freight should be delivered, e.g., to another trailer at the loading dock or to a particular holding and staging area within the terminal facility. This information can be communicated from the freight carrier's computer system to the remote computer and then displayed on the display device located on the lift truck.

The system can also include an executable program module, such as a loading module, to facilitate loading a trailer with freight. The loading module includes means for receiving information identifying the trailer into which the lift truck loads the piece of freight, and means for associating this trailer identifying information with a maximum load limit for that trailer. Each time a lift truck delivers a piece of freight to that trailer, the accumulated load weight for that trailer is determined by adding the weight of that piece of freight to the weight of all previously loaded pieces of freight. When the accumulated load weight reaches a predetermined level, in relation to the maximum load limit, a signal is generated that can be used to display information to the operator of the lift truck concerning the progress of loading, or alert the operator that the maximum load limit has been reached. The information identifying the trailer into which the piece of freight is loaded can be received in any of several ways. For example, the lift truck operator can use the scanner to scan a trailer identifying bar code located at the entrance to the trailer where the piece of freight is to be loaded. Alternatively, the trailer identification may be preassigned to a piece of freight and associated with the identifying information in the central computer or database. In this case, the scanning of the encode label will serve not only to identify the piece of freight, but can also recall the identity of the trailer into which the piece of freight is to be loaded. Alternatively, the trailer identification can be entered manually into the central computer by the operator of the lift truck using an input device associated with the computer, such as a touch screen, keyboard or pen.

In some embodiments, the video imaging device 20 is positioned to not only capture video image data of the display device 18, but can also be positioned so that video image data of the piece of freight itself is included as well. As a result, the captured video image data also includes the piece of freight so that any activity with respect to the piece of freight while being handled by the lift truck operator can be monitored on the second display device (See briefly FIG. 3). This can provide several benefits. First, it can be used to determine if any damage occurred to the piece of freight while being handled by the lift truck operator. Second, it can be used as a theft deterrent within the freight terminal.

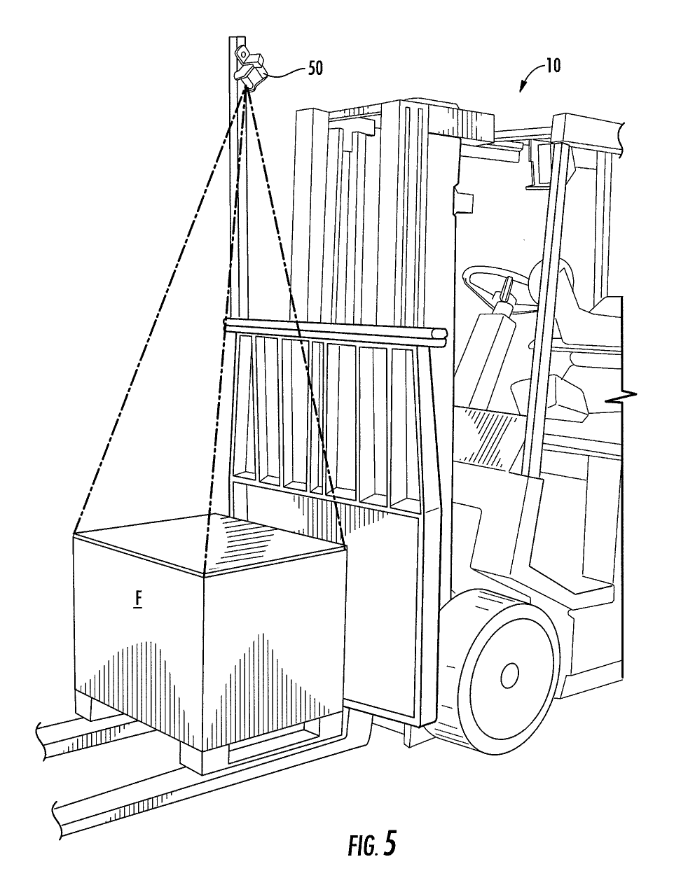

FIG. 5 illustrates an embodiment of the invention in which the lift truck includes an imaging device 50 that can be used to determine a volume for the piece of freight in conjunction with software that utilizes the image data to calculate an estimated volume of the piece of freight. The volume of the piece of freight can be used to improve packaging and loading efficiency on the trailers, adjusting shipping charges based on volume, and the like. In one embodiment, a single video imaging device can be used to capture volume data as well as video image data of the display device mounted on the lift truck. The freight carrier's computer system includes a program module that can determine the volume of the freight from the captured image data. The image data from the imaging device is sent to a processor where the data is processed to ascertain the volume of the freight shipment. For example, this processing operation can distinguish between known or constant volumes, such as the pallet, so that only the volume of the freight shipment is obtained. Suitable software for calculating volume is available from Valentine Robotics of Sterling Heights Michigan. This information is then correlated to the specific freight shipment being handled by the lift truck and is stored in a database along with the other information about that freight shipment.

The system of the present invention can also be used to help determine if the shipper has identified the correct freight classification for the piece of freight. For instance, the computer system can include one or more executable program modules for inputting the shipper-designated freight classification into the computer system and displaying a description of the freight classification. The operator of the lift truck can then compare the appearance of the piece of freight with the displayed description of the freight classification to determine if they match. If they do not match, the operator can flag the shipment of freight for reexamination prior to shipment. In one embodiment, one of the executable program modules is configured to cooperate with the wireless transmitter and is operable for communicating with a remote receiving site, such as the base computer, the input as to whether the appearance of the piece of freight matches the displayed description of the freight classification. This input can then be used by the carrier terminal's computer system to send a message, such as an email, to a freight classification specialist that identifies that piece of freight in need of reexamination and possible reclassification. A method and system for determining if a shipment of freight has been correctly classified by a shipper is discussed in greater detail in copending U.S. patent application Ser. No. 11/744,524 entitled System and Method for Shipping Freight, the content of which is hereby incorporated by reference.

With the addition of the video image data, cubic volume data, as well as the actual weight of the freight as determined by the forklift-mounted scale, all components of the freight bill are then known, namely: distance, as determined by point of origin and destination; weight and cubic volume, product classification; and the video image data of the freight, which can be used to determine other characteristics of the freight that may affect product classification. Distance will be calculated by a central database of known distances between a certain point of origin and a certain point of destination, actual weight will be determined by the weighting system, cubic volume will be determined by the system for dimensioning freight, and a photograph will be reviewed to ensure that the description of the freight and other characteristics are correct before the file is submitted to a central billing system for production of the invoice to the shipper.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for monitoring the handling of a shipment of freight, the system comprising:
a lift truck equipped for lifting and moving a piece of freight;
a weighing device associated with the lift truck for obtaining the weight of the piece of freight;
an input device accessible to an operator of the lift truck for receiving input of identifying information associated with the piece of freight;
at least one computer cooperating with the input device for receiving input of the identifying information associated with the piece of freight and cooperating with the weighing device for receiving weight of the piece of freight;
a display device having a display screen for displaying the identifying information and the weight of the piece of freight, the display device being positioned on the lift truck in a location that permits the operator of the lift truck to see information displayed on the display screen; and
a video imaging device disposed on the lift truck and positioned so that the video imaging device is capable of capturing video image data of the identifying information and weight displayed on the display screen, the video imaging device being operatively connected to said computer for transferring the captured video image data for the piece of freight from the video imaging device to the computer;
a first executable program module operable in said computer for associating the weight data with the identifying information;
a second executable program module operable in said computer for creating a segment of video image data corresponding to a period of time for which the lift truck operator is handling the piece of freight, and
a third executable program module operable in said computer for associating the thus created video segment with the identifying information;
a fourth executable program module operable in said computer for storing the weight data, video segment, and the identifying information in a database; and
a fifth executable program module operable in said computer for recalling and effecting display of the video segment.

2. The system of claim 1, wherein the second program module is configured to define a beginning point of the segment of video image data when the computer receives input of the identifying information for the piece of freight, and define an ending point of the segment of video image data when identifying information for a second piece of freight is received by the computer.

3. The system of claim 1, wherein the computer and the display device comprise a single integrated device.

4. The system of claim 1, wherein the computer is disposed at a receiving site and is in wireless communication with the input device, weighing device, display device, and the video imaging device.

5. The system of claim 4, further including a wireless transmitter disposed on the lift truck and communicatively connected to the video imaging device and operable for transmitting the captured image data to the receiving site.

6. The system of claim 1, wherein the computer is disposed on the lift truck.

7. The system of claim 1, wherein the input device comprises a touch pad that is displayed on the display device.

8. The system of claim 1, further including a second input device comprising a scanner that is accessible to the operator of the lift truck for inputting coded identifying information associated with the piece of freight into the computer.

9. The system of claim 1, wherein the video imaging device is positioned in a location on the lift truck so that the captured video image data includes image data of a piece of freight being handled by the lifted truck.

10. A system for monitoring the handling of a shipment of freight within a freight terminal, the system comprising:
a lift truck equipped for lifting and moving a piece of freight;
a weighing device associated with the lift truck for obtaining the weight of the piece of freight;
an input device accessible to an operator of the lift truck for receiving input of identifying information associated with the piece of freight;
at least one computer cooperating with the input device for receiving input of the identifying information associated with the piece of freight and cooperating with the weighing device for receiving weight of the piece of freight, the computer including a first executable program module for associating the weight data with the identifying information;
a display device having a display screen and cooperating with the computer for displaying information corresponding to the piece of freight, the display device being positioned on the lift truck in a location that permits the operator of the lift truck to see information displayed on the display screen;
a video imaging device disposed on the lift truck and positioned so that the video imaging device is capable of capturing video image data of the information displayed on the display screen;
a wireless transmitter communicatively connected to the video imaging device;
a receiver at a receiving site communicatively connected to the wireless transmitter and operable for receiving video image data transmitted by the transmitter; and
a second display device disposed within the freight terminal and communicatively connected to the receiver for receiving and displaying real time video image data of the information displayed on the display device of the lift truck so that handling of the piece of freight can be observed by personnel within the freight terminal.

11. The system according to claim 10, wherein the second display device is configured to receive and display video image data for two or more lift trucks.

12. The system according to claim 10, wherein the system includes an executable program module that is configured to indicate on the second display device if the operator of the lift truck has not input information into the computer within a specified amount of time.

13. The system according to claim 12, wherein the executable program module is configured to effect a change in color on the second display device to indicate if the operator of the lift truck has not input information into the computer within a specified amount of time.

14. The system according to claim 10, wherein the system includes an executable program module cooperating with the video imaging device and operable for creating a segment of video image data corresponding to a period of time for which the lift truck operator is handling the piece of freight.

15. The system according to claim 14, further including one or more executable program modules for associating the thus created video segment with the identifying information; and for storing the weight data, video segment, and the identifying information in a database.

16. The system according to claim 10, wherein said at least one computer comprises a remote computer disposed on the lift truck and a base computer at a receiving site within the freight terminal that is in wireless communication with said remote computer.

17. The system according to claim 10, wherein the video image device is positioned on the lift truck so that the piece of freight can be seen in the video image data.

18. A method for monitoring the handling of a piece of freight within a freight terminal comprising:
inputting identifying information associated with a piece of freight in connection with the handling of the piece of freight by the lift truck into a computer;
obtaining weight data for a piece of freight being handled by the lift truck using a weighing device disposed on the lift truck that is capable of obtaining the weight of each piece of freight handled by the lift truck;
displaying the identifying information and the weight data for the piece of freight on a display device that is cooperating with the computer for displaying information corresponding to the piece of freight, the display device being positioned on the lift truck in a location that permits the operator of the lift truck to see information displayed on the display screen;
capturing video image data with a video imaging device disposed on the lift truck, wherein the video imaging device is positioned so that the video imaging device is capable of capturing video image data of the information displayed thereon;
transmitting to a receiving site the captured video image data of the display device; and
displaying the captured video image data on a second display device disposed within the freight terminal.

19. The method of claim 18, further comprising the step of monitoring the captured video image data displayed on the second display device to ensure that the lift truck operator is obtaining weight data for the piece of freight.

20. The method of claim 18, further comprising the steps of:
transmitting the weight data obtained by the weighing device and the identifying information to the receiving site; and
storing the thus obtained weight data and identifying information for the piece of freight.

21. The method of claim 18, further comprising the step creating a segment of video image data corresponding to a period of time for which the lift truck operator is handling the piece of freight.

22. The method of claim 21, further comprising the step of storing the thus created segment of video image data with the identifying information in a database.

23. The method of claim 21, further comprising the steps of recalling and effecting display of the video segment on a display device.

24. The method of claim 18, further comprising the step of effecting a change in a visual appearance of captured video image data displayed on the second display device if the operator of the lift truck has not input information into the computer within a predetermined amount of time.
